(19) United States
(12) Patent Application Publication
(10) Pub. No.: US 2006/0003770 A1
(43) Pub. Date: Jan. 5, 2006

(54) Virtual phone service over wireless systems

(76) Inventor: Seyong Park, Somerset, NJ (US)

Correspondence Address: GIBBONS, DEL DEO, DOLAN, GRIFFINGER & VECCHIONE, 1 RIVERFRONT PLAZA, NEWARK, NJ, 07102-5497, US

(21) Appl. No.: 10/867,022

(22) Filed: Jun. 14, 2004

(51) Int. Cl. H04Q 7/20

(52) U.S. Cl. 455/445; 455/414.1; 455/466

(57) ABSTRACT

A system and method for routing telephone calls, data calls and other information to or from a wireless telephone using a low cost communications network (other than traditional telephone circuit switched network), where such network is at least part of a communications link through which a call is routed. An Internet gateway is situated proximate to the location of the wireless telephone and through which calls are cost-effectively routed. A virtual phone client (“VPC”) is implemented in the wireless telephone for communication with a virtual phone server (“VPS”), accessible via a wireless network. The VPC also communicates with an Internet gateway identified by the VPS. The communication in the origination or termination of a call between the VPC and VPS facilitates the routing of the call through the identified Internet gateway to effectuate the call with the wireless telephone at lower cost to the wireless telephone subscriber.

### FIELD OF THE INVENTION

The present invention generally relates to making telephone calls using a wireless telephone. More specifically, the present invention relates to making telephone calls via a relatively lower cost or least cost route using voice over the Internet protocol (“VoIP”).

### BACKGROUND OF THE INVENTION

When a user makes a telephone call using a current cellular or wireless telephone technology under a typical wireless service plan, she is subject to varying per minute rates. The rates are determined based on the specific calling plans that have home calling areas and roaming areas. If the user makes or receives a telephone call on her wireless telephone while in the home calling area, she is subject to the number of minutes allowed by her particular wireless plan. If she is over the allowed number of minutes, she will pay an additional charge per minute over the allowed amount. If the user makes or receives a telephone call while in the roaming area, then she is subject to not only minutes allowed by her plan but also must pay additional roaming charges per minute. Typically, roaming charges range from $0.45 to $0.65 per minute within continental United States.

Today, to make an international call or call from foreign country, other than the home calling country, the user needs to either rent another wireless telephone, get another international wireless calling plan, or use a calling card. All of these options will incur additional costs. Further, because wireless systems differ from continent to continent, the user's telephone has to be compatible with these systems in order to make and receive telephone calls. Such systems include AMPS, CDMA, GSM, UMTS and others.

Additionally, if the user desires to transmit or receive data from her wireless telephone, the current technology allows such transfer only using specific system compatibility parameters and subjects the user to high costs of transfer in addition to the plan premium. In some instances, such as international data transfer, the user's wireless telephone requires additional software programming and higher rates are associated with such data transfer. Further, for such transfers to take place, the wireless service providers must interconnect their network infrastructure with other service providers' infrastructure. This also incurs additional costs.

The problem becomes even more serious when Mobile Virtual Network Operators (“MVNO”) are involved. The MVNO offers wireless telephone service after a wholesaler's agreement is executed with wireless service providers. However, the service that MVNO offers heavily depends on the wireless service providers' infrastructure. This presents a great inconvenience, because MVNO cannot offer new service applications without requesting and making provisional changes in the wireless service providers' networks. Thus, the MVNO lose operating profits in addition to new revenue opportunities, because of their inability to offer such applications in time. This is despite the fact that MVNO pay a significant cost for implementation of such provisional updates.

Thus, there is a need for an improved wireless telephone and an environment supporting such wireless telephone for making and receiving international and other additional toll telephone calls, data, and other information, at lower cost while the mobile is located in a roaming area or otherwise.

### SUMMARY OF THE INVENTION

The present invention provides a system and method for reducing fees and costs associated with routing calls, e.g., international or domestic calls placed to or from a wireless telephone, regardless of whether it is located in a roaming service area or otherwise. The present invention is further directed to routing of telephone calls, data calls and other information to or from a wireless telephone using a low cost communications network without wireless service provider's infrastructure changes (other than traditional telephone circuit switched network), such as the Internet, where such network is at least part of a communications link through which a call is routed. It is possible to employ a voice over Internet protocol (“VoIP”) format for the call when routed over the Internet.

In particular, the present invention relates to the identification of a communications gateway situated proximate to the location of the wireless telephone (regardless of whether the telephone is in a roaming area or not) and through which calls (e.g., domestic or international) are cost-effectively routed. Examples of such communications gateway are an Internet gateway, a plurality of Internet gateways, or alternatively private branch exchange (“PBX”) switching systems.

The calls, routed through the identified Internet gateway, can be further routed through the Internet to a remote Internet gateway or Internet protocol (IP) telecommunication switch proximate the location of the dialed destination, where the call would be converted to the necessary format for completion to the dialed destination. Alternatively, the calls, routed through the identified Internet gateway, can be further routed through other types of telecommunications switches, such as PBX, located proximate to the desired destination.

In accordance with an exemplary embodiment of the invention, a software and/or hardware virtual phone client (“VPC”) is implemented in the wireless telephone. Such VPC communicates with a virtual phone server (“VPS”) accessible via a wireless network. The VPC also communicates with an Internet gateway identified by the VPS. The communication in the origination or termination of a call between the VPC and VPS facilitates the routing of such call through the identified Internet gateway to effectuate the call with the wireless telephone at lower cost to the wireless telephone subscriber.

Another aspect of the invention concerns a method for routing telephone calls placed from a wireless telephone that includes parsing dialing instructions received from the wireless telephone, selecting an Internet gateway from a plurality of Internet gateways based on at least a portion of the parsed dialing instructions, transmitting at least a portion of the parsed dialing instructions to the selected Internet gateway, and routing the telephone call via the selected Internet gateway.

Further features and advantages of the invention, as well as structure and operation of various embodiments of the invention, are disclosed in detail below will reference to the accompanying drawings.

### BRIEF DESCRIPTION OF THE FIGURES

The present invention is described with reference to the accompanying drawings. In the drawings, like reference numbers indicate identical or functionally similar elements. Additionally, the left-most digit(s) of a reference number identifies the drawing in which the reference number first appears.

FIG. 1 illustrates a prior art design of a mobile communications system.

FIG. 2 is a block diagram of an exemplary wireless telephone capable of operating via an Internet gateway according to the present invention.

FIG. 3 is a block diagram of an exemplary wireless telephone system, according to the present invention.

FIG. 4a is a flow chart illustrating an exemplary method of placing a telephone call using the present invention's wireless telephone system.

FIG. 4b is a flow chart illustrating another exemplary method of placing a telephone call using the present invention's wireless telephone system.

FIG. 4c is a flow chart illustrating yet another exemplary method of placing a telephone call using the present invention's wireless telephone system.

FIG. 4d is a flow chart illustrating yet another exemplary method of placing a telephone call using the present invention's wireless telephone system.

FIG. 5a is a flow chart illustrating an exemplary method for updating information on a wireless telephone using the present invention's wireless telephone system.

FIG. 5b is a flow chart illustrating another exemplary method for updating information on a wireless telephone using the present invention's wireless telephone system.

FIG. 6a is a flow chart illustrating an exemplary method for parsing dialing instructions using the present invention's wireless telephone system.

FIG. 6b is a flow chart illustrating another exemplary method for parsing international dialing instructions using the present invention's wireless telephone system.

FIG. 7 is a flow chart illustrating an exemplary method for location-based dynamic call routing assignment using the present invention's wireless telephone system.

FIG. 8 is a flow chart illustrating an exemplary distributed billing method using the present invention's wireless telephone system.

### DETAILED DESCRIPTION OF THE INVENTION

While the present invention is described herein with reference to illustrative embodiments for particular applications, it should be understood that the invention is not limited thereto. Those skilled in the art with access to the teachings provided herein will recognize additional modifications, applications, and embodiments within the scope thereof and additional fields in which the present invention would be of significant utility.

The present invention relates to systems and methods for making and receiving telephone calls using a wireless telephone over an Internet gateway, such as for example, a voice over the Internet protocol (“VoIP”) gateway. In an alternate embodiment, the user can employ a private branch exchange (“PBX”) switching system and place telephone calls using a PBX switch. According to one aspect of the present invention, a virtual phone client (“VPC”) in the form of, for example, software, from wave or hardware resides in the wireless telephone. The VPC is capable of communicating with a virtual phone server (“VPS”) also in the form of, for example, software, from wave or hardware residing in one or more components making up a wireless network. The VPC also communicates with an Internet gateway selected by the VPS.

In an embodiment, the call connection is set up using a forward calling feature of the present invention. In this case, to make a telephone or a data call, a user enters instructions into the wireless telephone. Depending on the nature of the call (telephone or data), the instructions are either a telephone number, an electronic mail address, a sequence of codes, or any other information needed for transmission of data to a destination. After completing the dialing instructions, the user sends them to the VPC. The destination can be another wireless telephone, a wireline telephone, a computer station, or any other device.

The VPC parses the instructions to determine the destination address and any other codes needed for transmission of data. The, parsed instructions are forwarded to the VPS. Based on the information contained in the parsed instructions and optionally, other criteria, the VPS selects an Internet gateway for routing the information received from the VPC. During the selection process of the Internet gateway, the VPS provides a destination address and an origination address (e.g., a user's wireless telephone number or an electronic mail address associated with the wireless telephone or an Internet Protocol address or other information identifying the origin of the information) to the Internet gateway.

Once the Internet gateway is selected, the VPS communicates an address of the Internet gateway back to the VPC. The VPS also connects to the Internet gateway to prepare for transfer of the information (e.g., connecting the call, transfer of email or other information transfer process). After receiving the Internet gateway address, the VPC connects to the Internet gateway to set up the connection for the call. The VPS-Internet gateway connection and the VPC-Internet gateway connection can happen simultaneously or one after the other. The VPS may also forward location, billing policy, and other information relating to the particular Internet gateway address.

After establishing VPC-Internet gateway connection, the user is connected to the desired destination using, for example, conventional VoIP techniques for connection link between the Internet gateway and the desired destination. Once the call is connected, the call control is transferred to the application programming interface (“API”) to handle the remaining call processing and termination.

In an alternate embodiment, the call connection is set up using a reverse calling feature of the present invention. In this case, the Internet gateway, selected for the call transmission to the destination, initiates a call to the wireless telephone and another call to the destination, after it has received the origin's and the destination's addresses. This feature is advantageous in areas where wireless service providers charge only the wireless user originating the call not the wireless user receiving the call. Also, the reverse calling feature is advantageous with respect to domestic long distance calling.

In alternate embodiments, the VPC-Internet gateway connection is established based on the information stored in a VPC cache. Thus, the user making a telephone or a data call connects to the Internet gateway using previously used and stored Internet gateway address. In this case, the VPC completely bypasses the VPS and directly connects to the previously used Internet gateway.

Techniques exist for routing calls over the Internet as VoIP calls are well known in the art. Suitable methods include Softswitch using Session Initiation Protocol or H.323 gateway. It should be readily understood that the particular method chosen for routing such calls over the Internet or other low cost network is not critical to practicing the present invention.

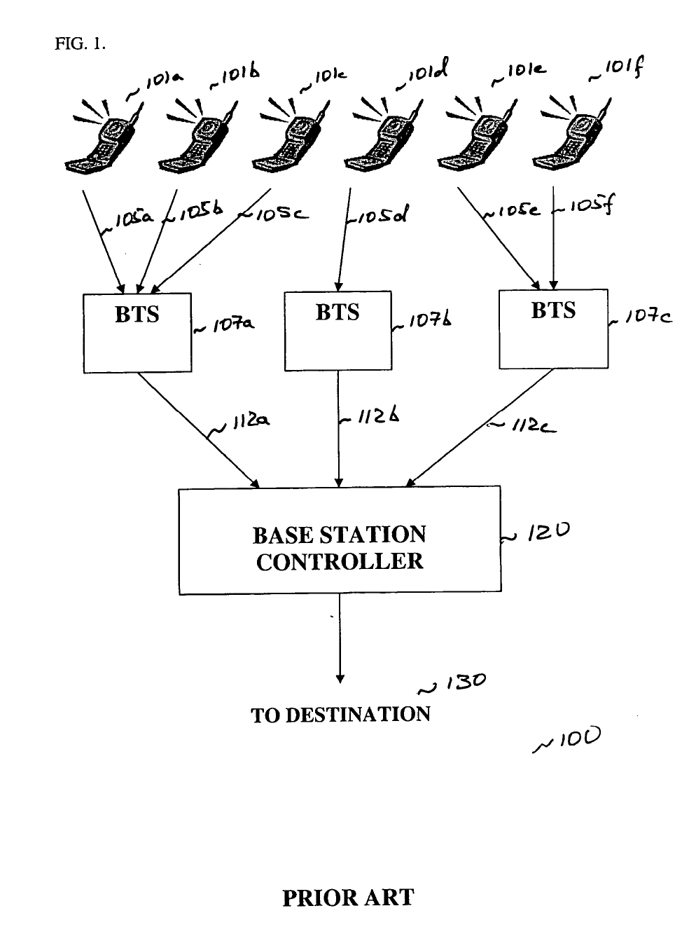

The following is a more detailed description of the present invention with respect to FIGS. 1-8.

FIG. 1 illustrates a conventional mobile telephone system 100 for making and receiving telephone calls. The system 100 includes a plurality of mobile telephones 101 (a, b, . . . , f). Each mobile telephone 101 communicates via wireless communication links 105 (a, b, . . . , f) with base transceiver stations 107 (a, b, c). The base transceiver stations 107, in turn, communicate with a base station controller 120. The base station controller 120 routes the calls via link 130 various components of the wireless system 100 (not shown in FIG. 1) to a desired destination.

A group of Base Transceiver Stations (“BTS”) 107 is located in a specific geographical area and communicates with an assigned Base Station Controller (“BSC”) 120. A combination of these base transceiver stations 107 and the base station controller 120 is called a Radio Access Network (“RAN”). Thus, a wider geographical area is subdivided into a plurality of RANs. Depending on mobile service provider and corresponding service plan, various billing rates are assigned to each telephone call made or received by the mobile telephone 101. Hence, each service provider has “home calling area” and “roaming area” networks. Typically, the home calling area is where the user is able to make and receive telephone calls and not be charged extra besides her monthly service fees. However, in the roaming area the user is not able to make and receive telephone calls without incurring additional charges. Further, depending on the roaming area and the mobile service provider, the charges vary. Hence, a user making a telephone call from her home calling area of New York City, N.Y., United States will pay lesser amount of money for the call than for the call made from the same wireless telephone in a roaming area in Seattle, Wash., United States.

Further, mobile telephones 101 configured to operate in the CDMA (code division multiple access) systems will not function in the GSM (Global System for Mobile Communications), unless a software and/or hardware is added to the mobile telephone's operating system. Additionally, the mobile telephone users in different countries have various billing policies associated with making and receiving telephone calls. Thus, mobile telephones 101 become very costly to the user, once the user moved out of her home calling area.

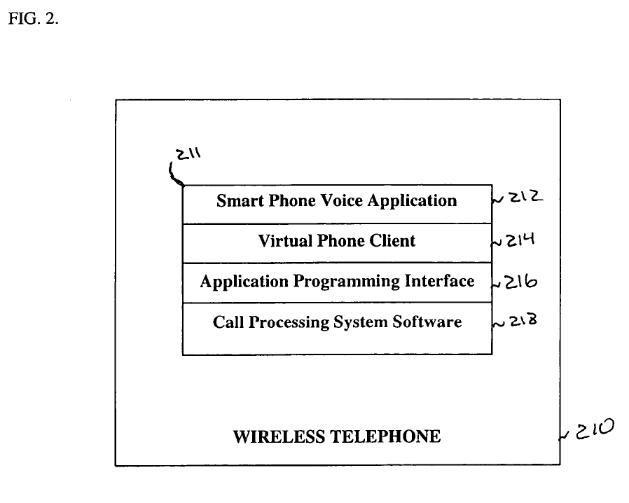

FIG. 2 is an illustration of components 211 of an exemplary wireless telephone 210, according to the present invention, for establishing a communicating link, e.g., making a call. The wireless telephone 210 includes a smart phone voice application 212, a virtual phone client 214, an application programming interface 216, and a call processing system software 216 in addition to other conventional hardware and software such as a key pad, a speaker, a microphone, and other components. As can be understood by one having ordinary skill in the relevant art, the wireless telephone 210 can include other components in addition to or instead of the above listed ones.

The smart phone voice application 212 can be implemented in, for example, a software, firmware or hardware, that allows the wireless telephone 210 to have a PC-like intelligence to enable the telephone to perform complex functions, such as processing stock price information, loading bank statements, etc. The smart phone voice application 212 is part of the wireless telephone software package typically preloaded in the telephone 210.

The virtual phone client (“VPC”) 214 can also be implemented in, for example, software, firmware or hardware, that interacts between the smart phone voice application 212 and the application programming interface (“API”) 216. The VPC 214 is described in more detail below. In one exemplary embodiment, the VPC can be downloaded from a remote server into the wireless telephone 210 that supports download of JTAPI and TAPI (where JTAPI and TAPI is a Java Telephony Application Programming Interface). In an alternate embodiment, the VPC performs a function call (described below) supported by the API 216 which is configured to facilitate retrieval of the wireless telephone's location information.

The API 216 can be, for example, another software frameware or hardware, component package that is typically preloaded in the telephone 210. The API 216 is an application program, which is used to request and carry out lower-level services by a telephone's operating system. In one exemplary embodiment, the API 216 is a set of standard software interrupts, calls, and data formats that application programs use to initiate contact with network services, telephone equipment or program-to-program communications. The applications use APIs to call services that transport data across a network. As can be understood by one having ordinary skill in the relevant art, API 216 may be configured according to the operational requirements of the wireless telephone system.

The call processing system software 218 sets up the intended connection in a switching system. The call processing system software 218 scans the trunk and/or station ports for any “requests” for service. Upon detecting a request, the system software 218 checks the stored instructions and look-up tables and sets the connection up accordingly.

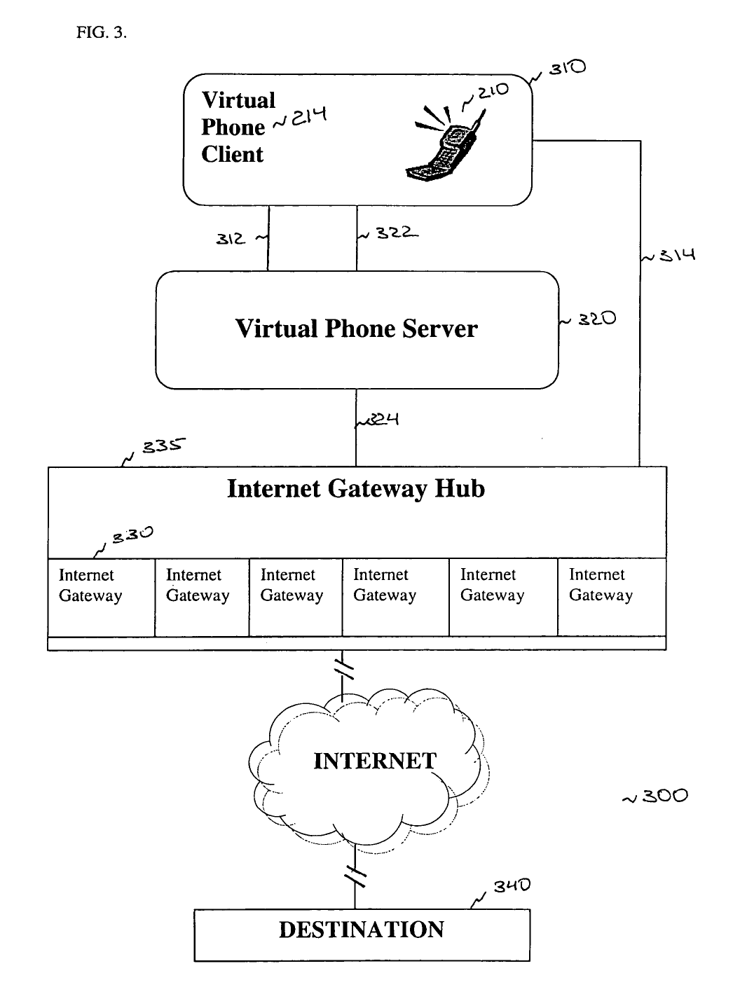

FIG. 3 is a block diagram of an exemplary communication system 300 of the present invention in which wireless telephone 210 operates. The system 300 includes a wireless station 310, a virtual phone server (“VPS”) 320, and an Internet gateway hub 335 containing a plurality of Internet gateways 330. The wireless station 310 communicates with VPS 320 and the Internet gateway hub 335. The VPS 320 further communicates with the Internet gateway hub 335. The Internet gateway hub 335 further connects the wireless station 310 to a destination 340. The Internet gateway hub 335 is any low cost communications network, which is other than a traditional telephone circuit switched network.

The Internet gateway hub 335 includes a tariff policy associated with routing calls through each gateway in the hub. Specifically, because of various different service providers of wireless telephone service, the tariff policies and Internet gateways are different for calls within home calling areas and roaming areas. To place a call via a least or a lower cost route, the VPS 320 selects a specific Internet gateway with a low tariff policy associated with making telephone calls. The selection is based on at least wireless telephone location, wireless telephone number, destination number, Internet gateway's tariff policy and other pertinent information.

In an alternate embodiment, the Internet gateway hub 335 may be a network of devices, computers, or other equipment communicating with each other without implementation of the circuit switched network boards.

The wireless station 310 is connected to the destination 340 via an Internet or any other low cost communications network, as shown in FIG. 3. Once the call connection is set up between the wireless station 310 and the selected Internet gateway 330, the Internet gateway 330 routes the call through the Internet. The call is routed through the Internet by, for example, a series of computers, routers, LANs, WANs, or other devices associated with the Internet.

It is possible to route the call over the Internet as a VoIP call. However, the particular method employed for routing the call over the Internet is not critical to practicing the present invention. Moreover, although the system 300 is being described using the Internet as the lower cost network for the routing of the call to the destination, it should be readily understood that the present invention is not limited to using the Internet as the low cost network. It further possible to use other networks having relatively low access and/or routing charges for routing the call from the gateway.

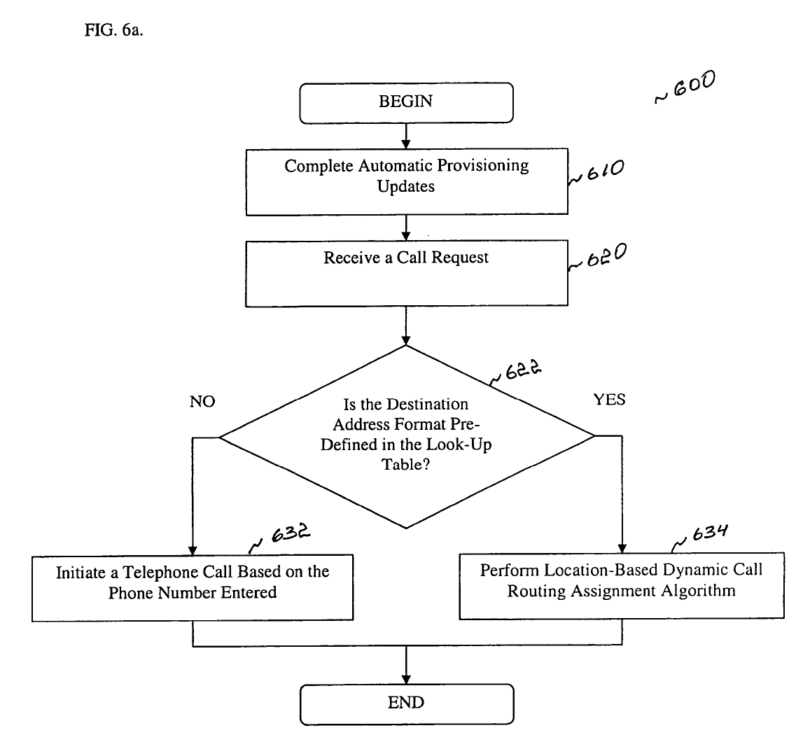

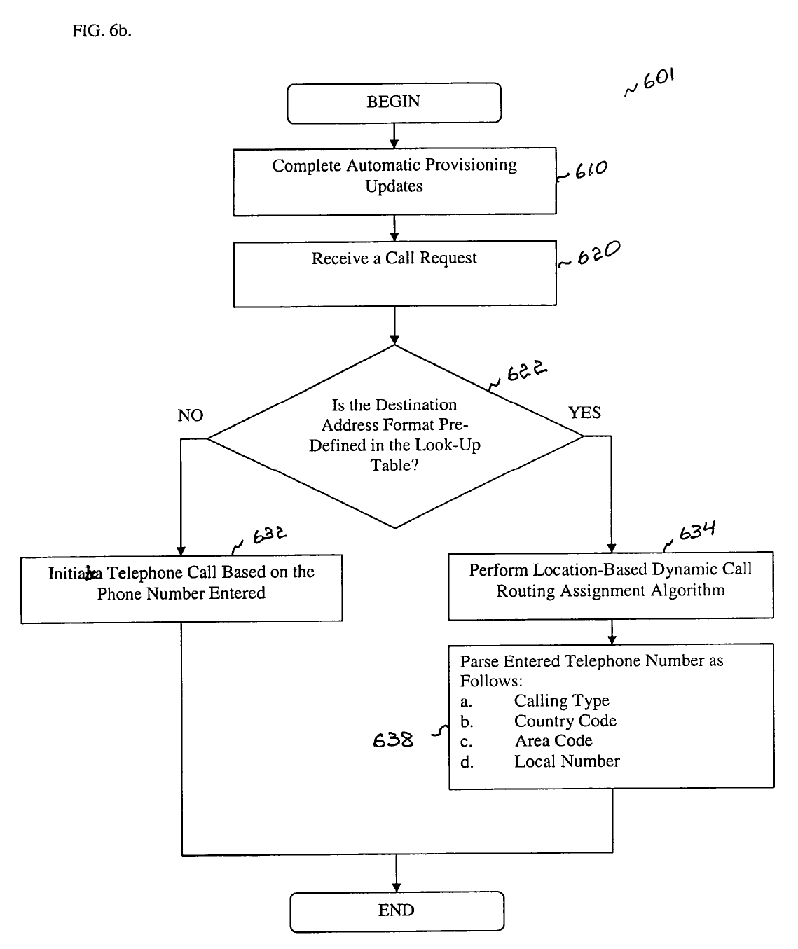

The wireless station 310 includes wireless telephone 210 that includes the VPC 214. In one exemplary embodiment, the VPC 214 is a software routine that interacts with the smart phone voice application 212 and the API 216. The VPC 214 receives dialing instructions from the wireless telephone 210. The dialing instructions can be a telephone number, an electronic mail address, or other information capable of sufficiently identifying a desired destination. For discussion purposes, the dialing instructions are assumed to be a telephone number. Upon receipt of the telephone number, the VPC 214 analyzes and parses the number to determine the destination. The parsing algorithm is further described in FIGS. 6a and 6b below.

Once parsed, the VPC 214 forwards the instructions to the VPS 320 via a communication link 322. The VPS 320 receives the parsed instructions and forwards them to the Internet gateway hub via a communication link 324. In an alternate embodiment, the Internet gateway hub is a voice over the Internet Protocol (“VoIP”) switch. In addition to the destination's parsed telephone number, the VPS 320 also forwards the wireless telephone 210's number. Upon receipt of the telephone numbers, a specific Internet gateway 330 is selected based on the user's wireless telephone number and destination number. In an alternate embodiment, the VPS 320 selects the Internet gateway 330 based on various combinations of location of the wireless telephone 210 (and the VPC 214), wireless telephone 210 number (or origination address), destination address, and/or Internet gateway's tariff's information.

After selection of the Internet gateway 330, the VPS 320 forwards an address of the gateway 330 to the VPC 214 via a communications link 312. The VPS 320 also forwards location information and a billing policy of the VPS 320 and the selected Internet gateway 330 provider to the VPC 214. Additionally, the VPS 320 triggers VPC 214 to begin a billing record for the call. After VPC 214 obtained the address of the Internet gateway 330, it sets up a telephone call connection to the Internet gateway 330 via a communications link 314. In an embodiment, link 314 is formed simultaneously with the VPS-Internet gateway link 324. In an alternate embodiment, link 314 is formed subsequent to the VPS-Internet gateway link 324. In yet alternate embodiment, link 314 is formed preceding the VPS-Internet gateway link 324.

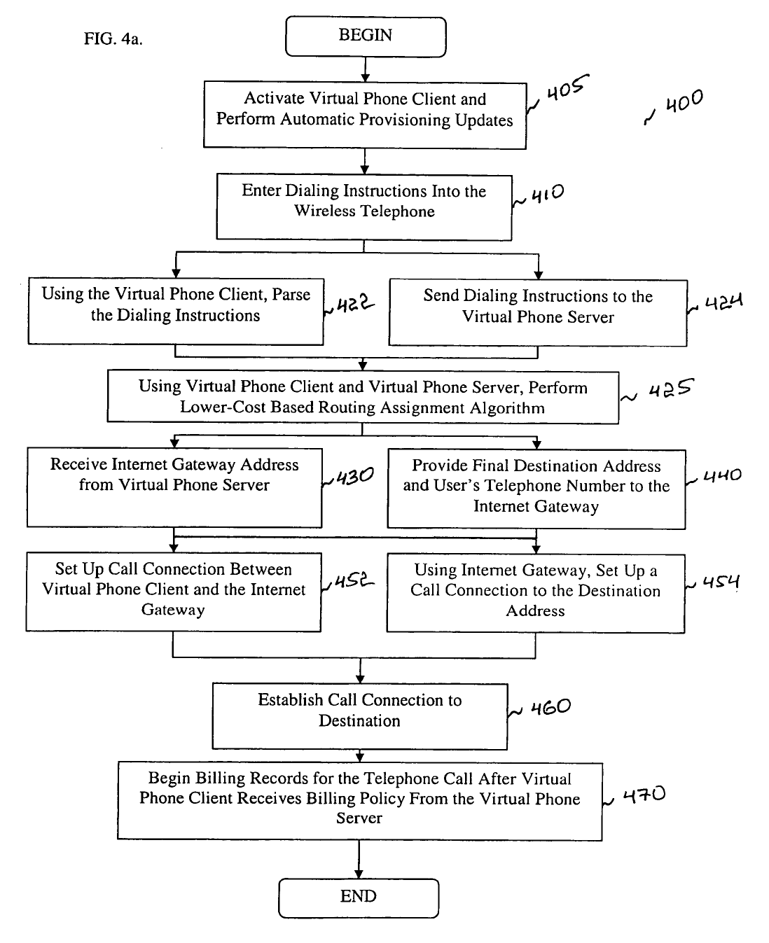

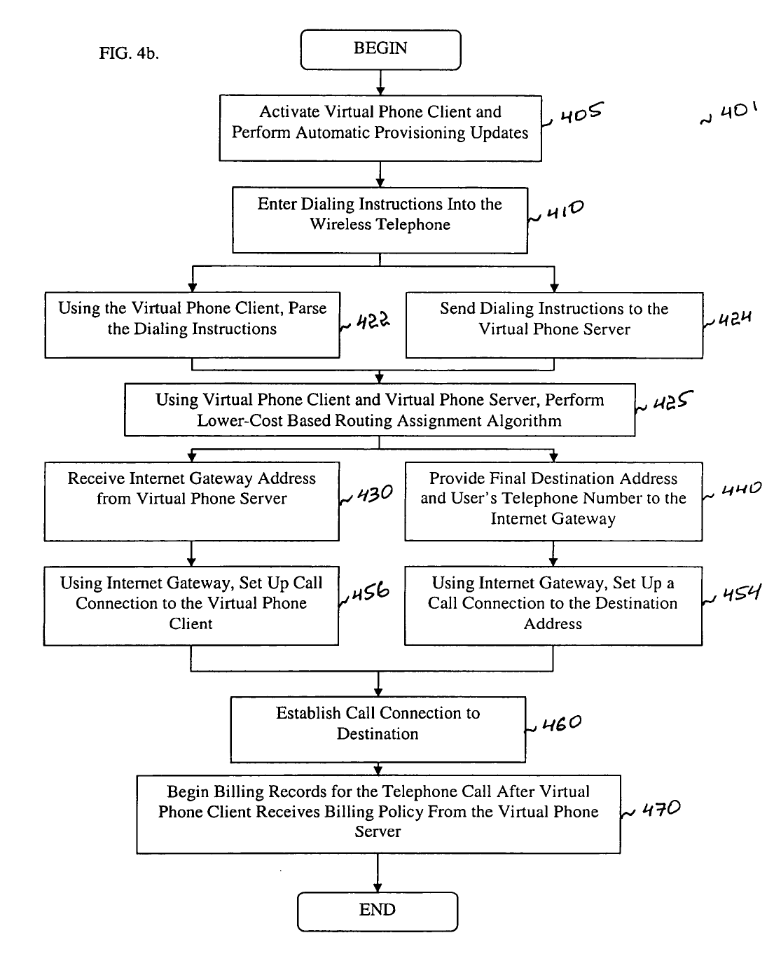

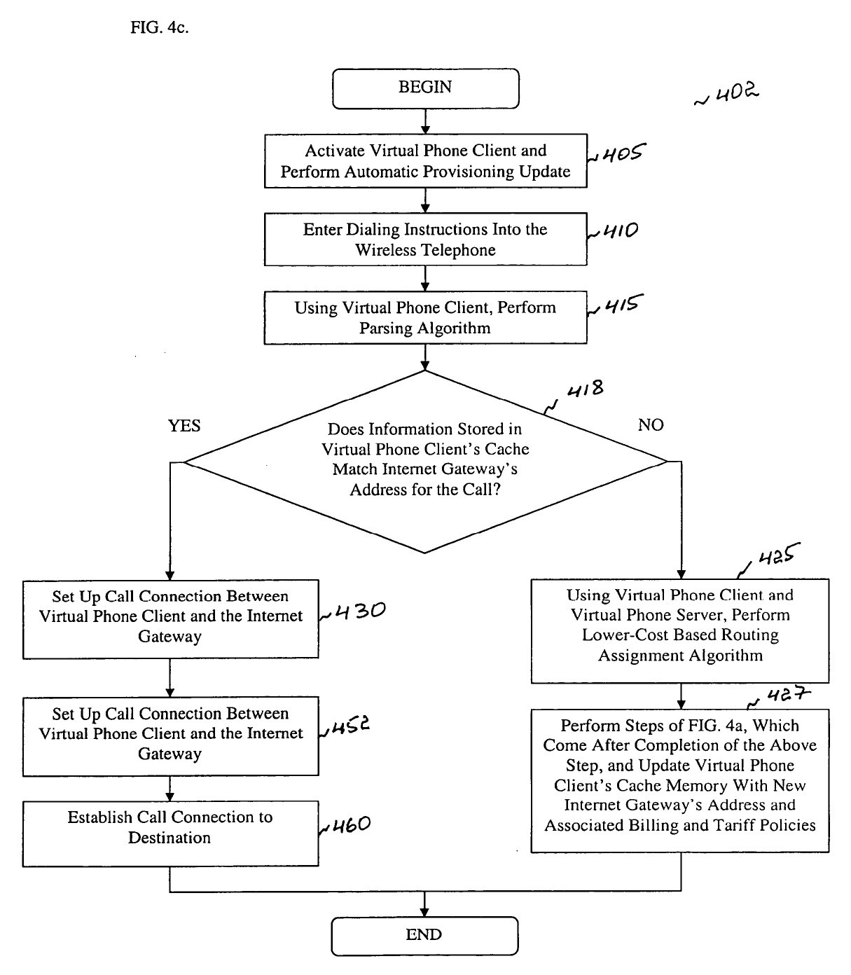

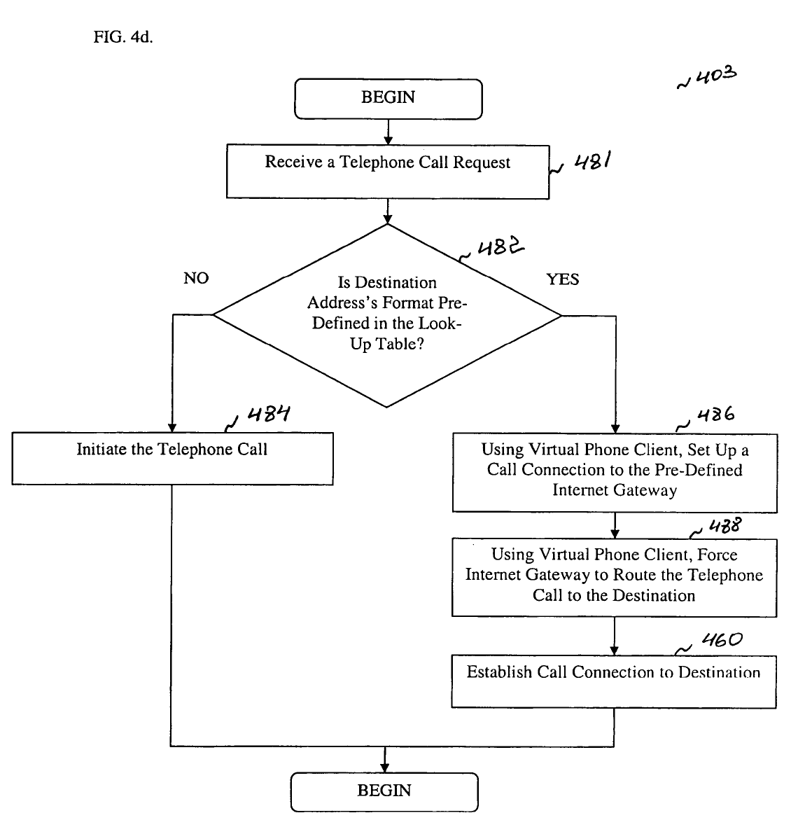

Upon formation of the communication links 314 and 324, a telephone call connection is established between the wireless telephone 210 and the destination 340. The above embodiment of the present invention will be described in more detail in FIG. 4a.

In an alternate embodiment, the selected Internet gateway 330 establishes a call connection using a reverse calling feature of the present invention. In this case, after the selected Internet gateway 330 receives the wireless telephone 210 number, the destination number, and other pertinent information from the VPS 320, it initiates calls to the wireless telephone 210 and the destination. After the calls are placed, the wireless telephone 210 is connected to its desired destination. This embodiment of the present invention will be described in more detail in FIG. 4b.

In an alternate embodiment, the VPC 214 connects to the Internet gateway 330 using an address of an Internet gateway previously stored in the VPC 214's cache memory. In this embodiment, the VPC 214, after activation, contacts a local VPS to obtain the Internet gateway address. Then, the VPC 214 places the address of the Internet gateway into its memory or cache. Thus, the next time the VPC 214 receives dialing instructions, it chooses the previously stored Internet gateway address and accesses the Internet gateway directly without contacting the VPS 320. This scenario is useful when the wireless telephone 210 is located in a remote area where a communications link with a local VPS cannot be easily established. Alternatively, this scenario is useful when the wireless telephone is most of the time located in the same home calling area and utilizes the same Internet gateway 330 at all times. This embodiment will be described in more detail in FIG. 4c.

In yet another alternate embodiment, the Internet gateway address may be programmed into the VPC 214. Thus, whenever the VPC 214 receives dialing instructions, it will always contact the same Internet gateway 330 for establishing a call. This embodiment of the present invention will be described in more detail in FIG. 4d.

The above VPC-VPS relationship provides great convenience for users who travel from one area to another. For example, a user having a wireless telephone equipped with VPC 214 with one home calling area can travel to another calling area (or roaming area) without having to install separate software or change the calling plan preferences. Thus, while in the wireless telephone is in other than home calling area (or roaming area), its VPC 214 contacts local VPS 320 and updates its calling preferences as well as billing policies associated with this area. In an alternate embodiment, VPC 214 contacts local VPS 320 whenever the user attempts to make a telephone call. The local VPS 320 provides VPC 214 with new calling preferences and billing policies along with an address of the Internet gateway 330. This way the VPC 214 will always be updated and the user will not be excessively billed for being out of her home calling area.

FIG. 4a is a flow chart diagram of an exemplary method 400 for routing information over an Internet gateway. FIG. 4a further illustrates steps performed by the system displayed in FIG. 3. For discussion purposes, the method 400 is described as making telephone calls over an Internet gateway. As can be understood by one having ordinary skill in the relevant art, the present invention is not limited to a method of making telephone call over an Internet gateway. The method 400 also describes transfer of information in any form from a wireless telephone via an Internet gateway, where the information includes electronic mail, graphic information, code sequences, and other information that can be transferred over a communications link. Thus, it is understood that whenever a reference is made to “a telephone call, ” a similar procedure is followed if an electronic mail, a sequence of codes, or other information is transferred via the Internet using the present invention.

The method 400 is referred to as a “forward calling method.” This means that the method 400 proceeds from VPC 214 contacting the VPS 320 and receiving all necessary information, including the Internet gateway's address through which the call will be placed. The VPS also contacts the Internet gateway and the call is set up by VPC 214 contacting the Internet gateway.

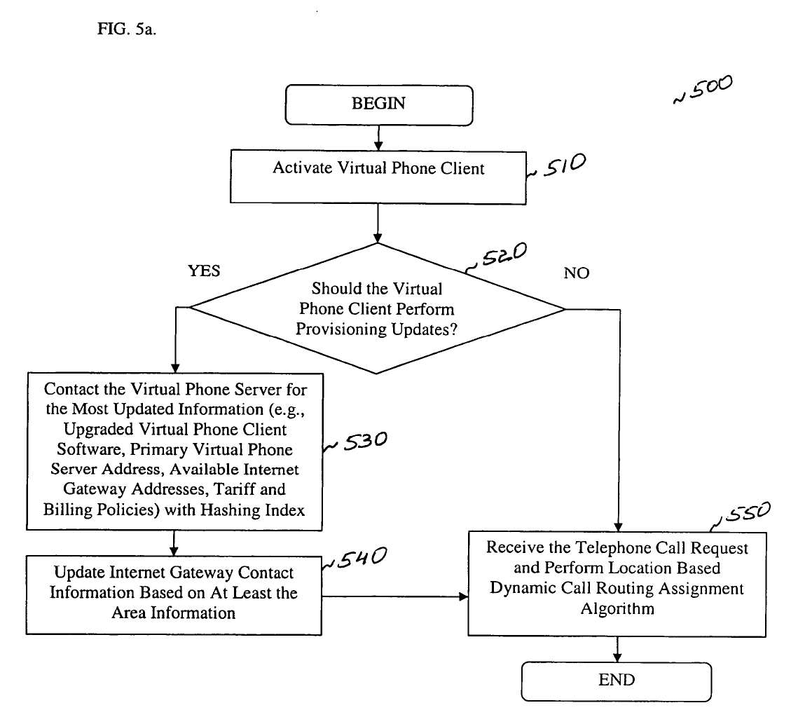

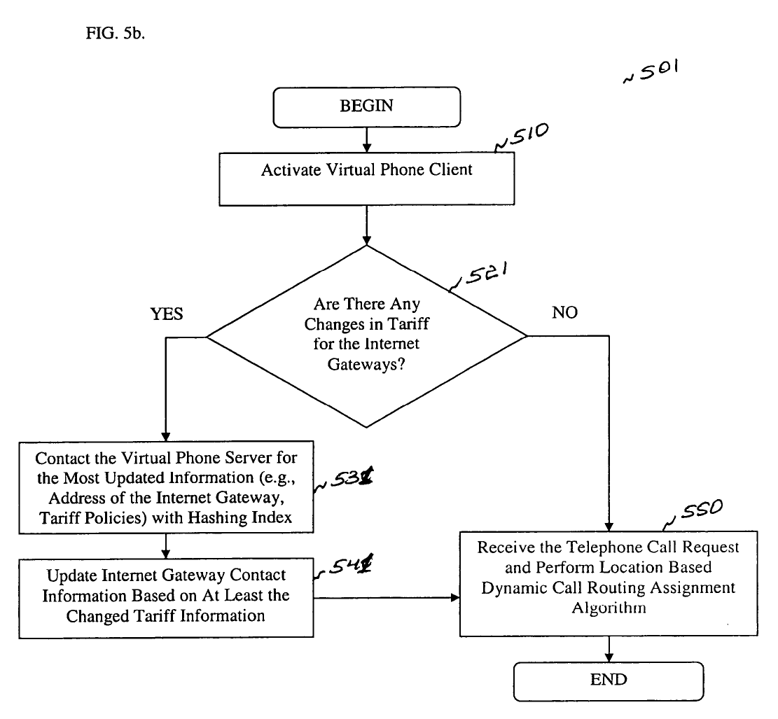

The processing in method 400 begins with step 405. In this step, the VPC 214 is activated. This means that a user either turns on the wireless telephone, or presses a button, or performs some other function to activate VPC 214. In another embodiment, the VPC 214 is automatically activated without user's intervention. After activation, the VPC 214 performs automatic provisioning updates. The VPC 214 can perform the updates after activation, or upon receiving user's instructions, or automatically at preset periods, or in any other way. During these updates, the VPC 214 contacts the VPS 320 to determine whether any new information should be uploaded to the VPC 214 with respect to the location information, primary VPS address, Internet gateway address, billing and tariff policies, or any other information. This process is further described in FIGS. 5a and 5b below.

The processing then proceeds to step 410. In this step, the user enters dialing instructions into the wireless telephone. In an embodiment, the user enters a telephone number using a key pad on the telephone and presses a “SEND” (or “TALK” ) button. As can be understood by one having ordinary skill in the relevant art, any other form of entry of information can be employed.

The processing proceeds to steps 422 and 424. In step 422, the VPC 214 parses the dialing instructions received by the wireless telephone. In an embodiment, the VPC 214 determines specific codes from the telephone number entered by the user. The parsing algorithm is described below with respect to FIGS. 6a and 6b. Using these codes, proper destination and billing policy is determined for this particular telephone call. In step 424, the VPC 214 sends the dialing instructions to the VPS 320. The VPS 320 receives the parsed dialing instructions and the user's wireless telephone identification information (e.g., user's telephone number) and any other relevant information.

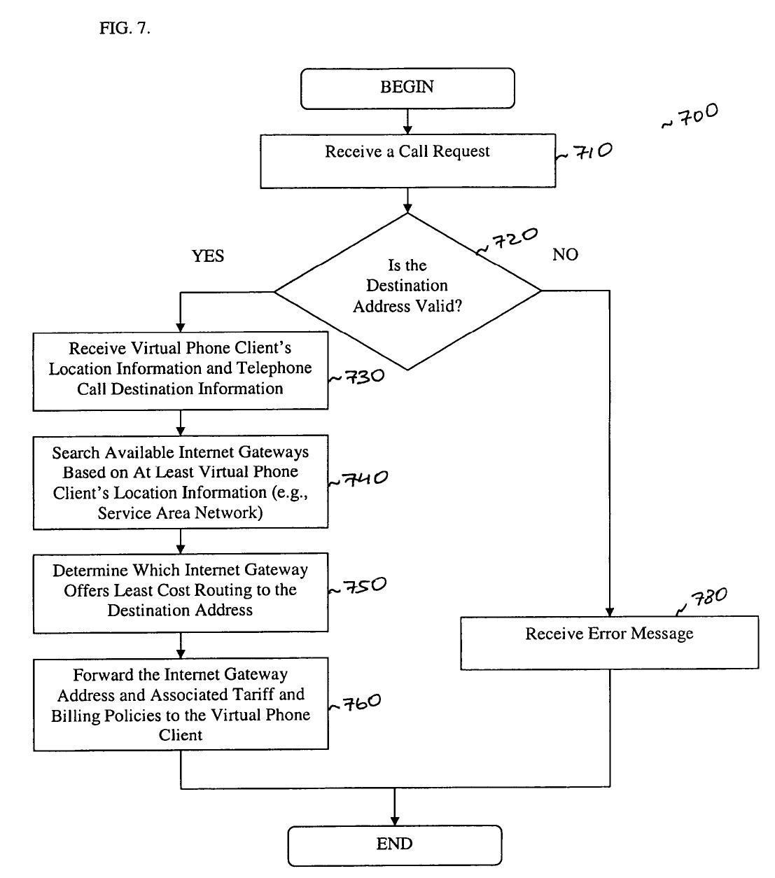

The processing then proceeds to step 425. In step 425, the VPC 214 and VPS 320 perform a lower-cost routing assignment algorithm. This algorithm determines how the telephone call is placed, i.e., through which Internet gateway. In an embodiment, this is determined based on the user's wireless telephone plan information. This algorithm is more specifically described with respect to FIG. 7. The processing then proceeds to steps 430 and 440.

In step 430, the VPS 320 provides the VPC 214 with the Internet gateway 330. The VPS 320 determines through which Internet gateway 330 to route the telephone call based upon information entered by the user and the identification information of the wireless telephone. In step 440, the VPS 320 also provides the Internet gateway with the user's identification information (e.g., user's telephone number) and the destination number (i.e., dialing instructions). Then the processing proceeds to steps 452 and 454.

In step 452, the VPC 214 sets up a call connection with the selected Internet gateway 330. The VPC 214 creates such connection based upon information received from the VPS 320 about the Internet gateway 330. The VPS 320 also establishes connection with the Internet gateway 330. As stated above, the VPC-Internet gateway and the VPS-Internet gateway connections can be established either simultaneously or one after another.

In step 454, the selected Internet gateway 330 sets up a call connection to the destination 340. The Internet gateway 330 sets up a call connection using the destination address received from the user. It can set it up directly with the destination 340 or connect to another Internet gateway, which will set up call connection to the destination 340. The processing then proceeds to step 460.

In step 460, the call is connected to the destination 340 based on the information entered by the user, the Internet gateway 330 and the calling preferences of the wireless telephone.

After the call connection is made, the processing proceeds to step 470. In this step, a billing record for the telephone call is created. The VPC 214 creates such records based upon the information received from the VPS 320. This information can include billing and tariff policies associated with the selected Internet gateway 330.

FIG. 4b is a flow chart illustrating another embodiment of a method 401 for placing telephone calls according to the present invention. The method 401 is referred to as a “reverse calling” method. The method 401 is similar to method 400 described above, with the exception of step 456. In step 456, the selected Internet gateway 330 initiates calls to the VPC 214 and the destination. This can be done simultaneously or one after the other. The Internet gateway 330 performs this function after receiving information from VPS 320, such as wireless telephone's number, wireless telephone location information, destination number, etc.

The method 401 is convenient for users in an international market, where billing/tariff policies are different from the United States market. For examples, in some countries the service provider companies charge only the wireless telephone user who originates the call and not the wireless user on whose wireless telephone the call terminates. This method is also advantageous for users in a domestic market. This method allows selection of lower tariffs associated with placement of telephone calls from a wireless telephone.

FIG. 4c is a flow chart illustrating an exemplary method 402 for routing telephone calls using information stored in the VPC 214 memory or cache. This method is useful when a specific Internet gateway is desired or if no other Internet gateway is available. Additionally, this method does not involve a use of the VPS 320.

The processing begins with steps 405 and 410. These steps were described above with respect to FIGS. 4a and 4b. Then the processing proceeds to step 415. In this step, the VPC 214 performs a parsing algorithm. The parsing algorithm parses the dialing instructions received from the user. This algorithm is further described with respect to FIGS. 6a and 6b. The processing then proceeds to step 418.

In step 418, the VPC 214 determines if the information stored in its memory or cache matches the Internet gateway's address for the telephone call. This is done based on the telephone number, location information, and other information described above. If there is a match, then steps 430, 452 and 460 are sequentially performed (alternatively, steps 430, 456, and 460 can be performed). These steps are described in FIG. 4a (alternatively, in FIG. 4b) above.

If there is no match, the processing proceeds to step 425. Step 425 is also described in FIGS. 4a and 4b. In that step, the lower-cost based routing assignment algorithm (See, FIG. 7) is performed. Then, in step 427, the method 402 performs all steps of FIG. 4a (or FIG. 4b) that follow step 425. It also updates VPC's memory or cache with new Internet gateway's address as well as billing and tariff policies associated with the new Internet gateway.

In an embodiment, the VPC 214 can perform the update in step 427 periodically or at a preset schedule. For example, the VPC 214 can update its Internet gateway address once every set time period. In an alternate embodiment, the VPC 214 can update its Internet gateway address 330 automatically after detecting that the wireless telephone moved into a new VPS and/or Internet gateway area. In yet a further embodiment, the VPC 214 perform the update based on a signal received from the VPS prompting VPC to perform update procedure. In yet another embodiment, the VPC 214 does not perform the update but instead uses an Internet gateway address stored in its cache memory. In this scenario, the VPC 214 uses the stored address to route telephone calls.

FIG. 4d is a flow chart illustrating another exemplary method 403 for routing a telephone call using a predetermined service information. This method is useful if a use of a specific service is desired. The method is also useful for making international telephone calls. The processing begins in step 481. In this step, a request for routing a telephone call is received. In an embodiment, the VPC 214 can receive such request. The request is received after the user enters the numbers on the telephone's key pad and presses a “SEND” (or “TALK”) button. It can be understood by one having ordinary skill in the relevant art that other methods of entering call requests into a telephone can be used.

Then, in step 482, the method 403 determines whether the destination address's format is pre-defined in the look-up table. For example, step 482 determines if the telephone number begins with “011” or other prefixes for countries other than U.S. and matches it to one of the entries in the look-up table.

If the destination address does not match any entries in the look-up table, then the processing proceeds to step 484. In this step, a telephone call is initiated using a wireless telephone software loaded in the wireless telephone.

If the destination address matches an entry in the look-up table, then the processing proceeds to step 486. In this step, the VPC 214 sets up a call connection to the pre-defined Internet gateway 330. Then, in step 488, the VPC 214 also prompts the Internet gateway 330 to route the telephone call to the destination 340. This is done using the information that VPC 214 supplies to the Internet gateway 330, such as the destination address, the origination address, and other information described above.

Then in step 460, a call connection to the destination 340 is established.

FIG. 5a is a flow chart illustrating a method 500 for updating information on the wireless telephone. It is possible for VPC 214 to perform steps of the method 500 after VPC 214 is activated as described in FIGS. 4a and 4b. As can be understood by one having ordinary skill in the relevant art, the method 500 is not limited to the entry of telephone numbers. The method 500 can also be used to update a wireless telephone's electronic addresses, code sequences, programming steps, or other stored information.

Method 500 begins with step 510. In step 510, the VPC 214 is activated. In an embodiment, the VPC 214 is activated by turning on power in the wireless telephone. In an alternate embodiment, the VPC 214 is activated upon receiving dialing instructions.

In step 520, the VPC 214 determines whether it should perform provisioning updates. This means that the VPC 214 determines whether information stored in the VPC 214 needs updating. There are several triggering events that can facilitate such determination. For example, these events include change of wireless telephone's location between home and roaming areas. Such areas are defined by the plan provider. When a wireless telephone account is created, a home networking or a home calling area is assigned to the telephone. The size of the home networking area depends on plan selected by the user. In an alternate embodiment, the home networking area can be a network of users, systems, or equipment communicating with the wireless telephone communicates.

If the VPC 214 determines that it does not need to perform provisioning updates, then the processing proceeds to step 550. In step 550, the VPC 214 receives the dialing instructions or the telephone number and performs a dynamic call routing assignment algorithm. The dynamic call routing assignment algorithm is described below with respect to FIG. 7.

However, if the VPC 214 determines that it needs to perform provisioning updates, then the processing proceeds to step 530. In step 530, the VPC 214 contacts the VPS 320 to get the most updated information. The information includes an updated primary VPS address, any relevant VPC 214 software, any VPC service credentials (such as authentication keys), Internet gateway address with hashing index, updated billing policies associated with a particular VPS and Internet gateway, and a location information associated with the wireless telephone 210 and its VPC-VPS relationship. Other parameters can be updated as well.

Based on the received information, the VPC 214 updates its Internet gateway address contact information based on at least the area information, as shown in step 540. In an embodiment, the VPC 214 can perform steps 530 and 540 periodically or at a preset schedule. For example, the VPC 214 can update its Internet gateway address once every set time period. In an alternate embodiment, the VPC 214 can update its Internet gateway address 330 automatically after detecting that the wireless telephone moved into a new VPS and/or Internet gateway area. In yet a further embodiment, the VPC 214 performs steps 530 and 540 based on a signal received from the VPS prompting VPC to perform update procedure. In yet another embodiment, the VPC 214 does not perform steps 530 and 540 but instead uses an Internet gateway address stored in its cache memory. In this scenario, the VPC 214 uses the stored address to route telephone calls.

FIG. 5b is a flow chart diagram illustrating method 501 for updating information on a wireless telephone based on changes in the Internet gateway's tariffs. Method 501 is similar to method 500 described above with the exception of step 521, 531, and 541.

In step 521, method 501 determines whether there are any changes in the Internet gateway's tariffs. Such changes includes new tariff offers or changes to the existing Internet gateway's tariff policies.

If there are no changes in the Internet gateway's tariff policies, then the method 501 proceeds to step 550 described above with respect to method 500.

If there are changes in the Internet gateway's tariff policies, the method 501 proceeds to step 531. In step 531, the VPC 214 contacts the VPS 320 to receive the most updated information based upon at least the wireless telephone's location with respect to particular tariffs associated with that location. Then the processing proceeds to step 541.

Step 541 is similar to step 540 described above with respect to method 500. In step 541, the VPC 214 updates its Internet gateway contact information based upon at least new tariff information associated with the selected Internet gateway. As stated above, the new tariff information is based upon changes in the tariff policies offered by Internet gateway's wholesalers. Such policies can changes on a daily basis. In an embodiment, the VPS 320 acts as a database of various Internet gateways' billing/tariff policies and facilitates selection of the least cost route for the call. In an alternate embodiment, the VPS 320 collects information about the Internet gateways' billing/tariff policies in real time and determines which gateway to select based on the call information (call origination, call destination, etc.).

FIG. 6a is a flow chart diagram illustrating an exemplary method 600 for parsing dialing instructions (or a destination address), according to the present invention. As can be understood by one having ordinary skill in the relevant art, method 600 is not limited to parsing telephone numbers. Method 600 is suitable for parsing any type of information. The method begins with step 610. In step 610, the wireless telephone completes automatic provisioning updates. By completing this step, the wireless telephone now has the most current information with respect to the roaming preferences, contact information, and billing policies.

The processing then proceeds to step 620. In step 620, the VPC 214 receives a call request. As stated above, the call request can be, for example, in the form of a telephone number, electronic mail address, or other information.

In step 622, the wireless telephone determines whether the entered telephone number or other information is predefined in a lookup table. By determining whether the entered telephone number is in a lookup table, the system is able to translate the entered number into routing instructions for the system. This way the system will recognize where to route the telephone call. An example of a lookup table is a least or lower cost routing table. In an alternate embodiment, the lookup table is a set of addresses (source and destination) used by a bridge or router to determine what should be done with a date packet. As the data packet comes in, its address information is read and compared with the information in the lookup table. Depending on the information, the bridge may forward the packet, or discard it, leaving it for the local LAN. Many bridges and routers can build their lookup tables as they operate.

If the received telephone number is not in the lookup table, then the processing proceeds to step 632. In step 632, the wireless telephone initiates a telephone call based on the telephone number entered. This is done using a software loaded in the wireless telephone.

If the destination address is found in the lookup table, then the processing proceeds to step 634, where the VPC 214 performs the location-based dynamic call routing assignment algorithm. This algorithm is described below with respect to FIG. 7.

FIG. 6b is a flow chart diagram illustrating exemplary embodiment of a parsing algorithm 601 for parsing international dialing instructions. The method 601 is similar to method 600 with the exception of step 638. In step 638, the entered telephone number is parsed based on the calling type, country code, area code, and a local number. As can be understood by one having ordinary skill in the relevant art, other parsing categories can be used.

Also, in step 623, by determining whether the destination address' format is pre-defined in the look-up table, the method 601 determines whether the first three numbers dialed are equal to “011.” If yes, then the processing proceeds to steps 634 and 638. The step 634 is described with respect to step 600. If not, then the processing proceeds to step 632, described above.

FIG. 7 is a flow chart that illustrates an exemplary method 700 for location-based dynamic call routing assignment algorithm. In step 710, a user places a telephone call request through the VPC-VPS system from her wireless telephone.

The method 700 then proceeds to step 720, where the system determines whether the destination address (or telephone number) entered by the user is a valid number. In an embodiment, it can be done by comparing the destination number against the numbers in the destination number lookup table contained in the system (e.g., VPS or the Internet gateway).

If the number is not valid, then an error message is received, as indicated in step 780. After that, the telephone call is terminated.

However, if the destination telephone number is valid, the processing proceeds to step 730. In step 730, the VPS 320 receives VPC 214's location information and telephone call destination information (i.e., destination address). This is done in order to receive an Internet gateway address and an appropriate billing policy. The VPC 214 sends a parsed telephone number to the VPS 320.

The processing then proceeds to step 740, where the VPS 320 searches available Internet gateways to route the telephone call using least or lower cost available. The search is performed based on the destination telephone number sent the Internet gateway hub for selection of an appropriate Internet gateway. In an embodiment, the Internet gateway is selected based on the comparison between the destination telephone number and the numbers in the lookup table located in the Internet gateway hub. In an alternate embodiment, selection of the Internet gateway depends upon which VPS 320 is contacting the Internet gateway hub. As can be understood by one having ordinary skill in the relevant art, other ways of selecting an Internet gateway are possible.

After searching, the VPS 320 determines which Internet gateway offers the lowest cost possible for the particular telephone call, as shown in step 750. In one embodiment, this procedure is done either simultaneously with VPS 320 establishing connection to the Internet gateway. In an alternate embodiment, the VPC 214 establishes connection to the Internet gateway after VPS 320 establishes connection with the Internet gateway. In yet another embodiment, the VPC 214 establishes connection to the Internet gateway before VPS 320 establishes connection with the Internet gateway.

In an alternate embodiment, the Internet gateway sets up the telephone call. Once the Internet gateway receives information about the wireless telephone making the call (i.e., the origination number, the location of the wireless telephone, etc.) and the destination number, it initiates calls to the VPC 214 of the wireless telephone 210 and the destination. These procedures can be done simultaneously or one after the other. After the connections are made, the call is placed from the wireless telephone 210 to its desired destination.

In addition to initiating the call, the VPS 320 sends the Internet gateway address and the associated billing and tariff policies to the VPC 214, as shown in step 760. Then, the VPC 214 is interconnected using an address of the Internet gateway to the final destination 340. When telephone call is connected, the VPC 214 begins a billing policy record for the telephone. The VPS 320 sends the billing policy to the VPC 214 when VPC 214 provides the VPS 320 with the its origination and destination numbers. The billing policy includes but is not limited to minutes used per call, total minutes used, charge per minute, and other information.

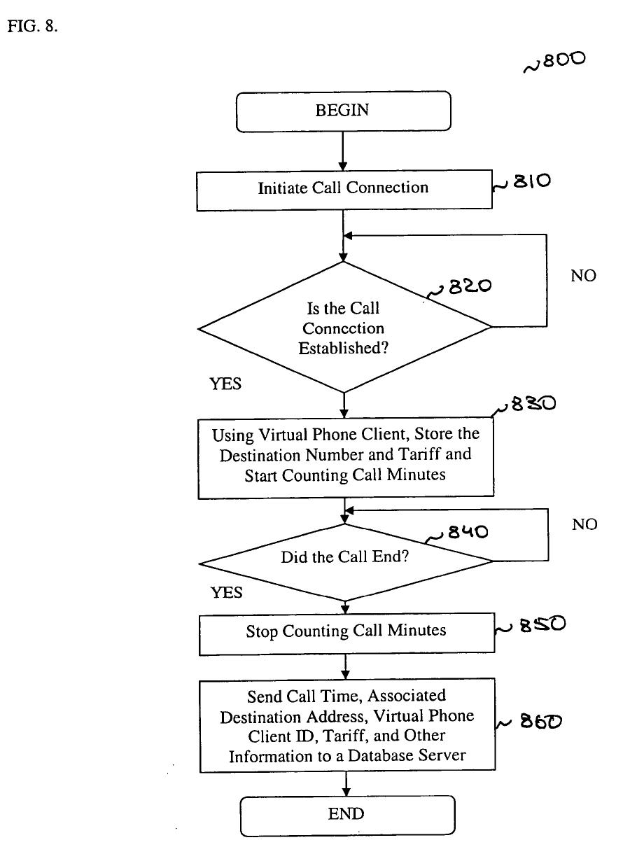

FIG. 8 illustrates an exemplary distributed billing method 800, according to the present invention. In this embodiment, the virtual phone client 214 includes a wireless telephone 210's user's call(s) record, which includes at least minutes used and tariff information with respect to the call. The VPC 214 can regularly update the billing/tariff information in a database system contained at a Mobile Virtual Network Operator (“MVNO”) or any other network operating entity. The method 800 allows for more efficient management of billing/tariff data associated with a call. The method 800 begins with step 810, where the call is initiated. Then the processing proceeds to step 820.

In step 820, the method 800 determines whether the call connection is established. If the call is not established, then the method 800 recursively returns to step 820. However, if the call is established, then the method 800 proceeds to step 830. In step 830, VPC 214 stores the destination number and tariff information and starts counting call minutes.

Then, the processing proceeds to step 840. In step 840, the method 800 determines whether the call ended. If not, then the processing proceeds to the beginning of step 840. If the call ended, then the method 800 instructs VPC 214 to stop counting call minutes in step 850 and proceed to step 860.

In step 860, the call time, associated destination address, VPC ID, tariff, and other information are sent to a database server.

Example embodiments of the methods, circuits, and components of the present invention have been described herein. As noted elsewhere, these example embodiments have been described for illustrative purposes only, and are not limiting. Other embodiments are possible and are covered by the invention. Such embodiments will be apparent to persons skilled in the relevant art(s) based on the teachings contained herein. Thus, the breadth and scope of the present invention should not be limited by any of the above-described exemplary embodiments, but should be defined only in accordance with the following claims and their equivalents.

What is claimed:

1. A method for routing telephone calls placed from a wireless telephone comprising the steps of:
receiving dialing codes received from a wireless telephone;
selecting an Internet gateway from a plurality of Internet gateways based on at least a portion of said received dialing codes;
transmitting instructions responsive to at least a portion of said received dialing codes to the selected Internet gateway; and
routing the telephone call via the selected Internet gateway.

2. The method of claim 1, further comprising that said routing and transmitting steps are performed substantially simultaneously.

3. The method of claim 1 wherein said routing step is performed after said transmitting step.

4. The method of claim 1 wherein said routing step further comprises a step of formatting said telephone call step information into a Voice over Internet Protocol format.

5. The method of claim 1, wherein said routing step further comprises a step of formatting said telephone call step information into a private branch exchange format.

6. The method of claim 1, wherein said dialing codes are selected from a group consisting of: telephone number, electronic mail address, and code sequences.

7. The method of claim 1, wherein said receiving step further comprises a step of:
parsing said dialing codes.

8. The method of claim 1, wherein said transmitting step further comprises a step of:
transmitting a billing policy associated with said selected Internet gateway.

9. The method of claim 1, further comprising a step of:
using said selected Internet gateway, contacting said wireless telephone and a telephone call's destination.

10. The method of claim 1, further comprising a step of:
storing a telephone call's billing information.

11. A wireless telephone comprising:
a virtual phone client adapted to parse dialing codes based on at least one of a plurality of wireless telephone parameters; and
wherein said virtual phone client initiates a call based on at least a portion of said parsed dialing codes by transmitting instructions to a virtual phone server for routing said call via an Internet gateway.

12. The wireless telephone of claim 11, wherein said virtual phone client is a residential software preloaded in the wireless telephone supporting download of applications selected from a group of JTAPI and TAPI applications.

13. The wireless telephone of claim 11, wherein said virtual phone client further comprises an application programming interface that is configured to facilitate retrieval of the wireless telephone's location information.

14. The wireless telephone of claim 11, wherein said virtual phone client initiates a telephone call.

15. The wireless telephone of claim 11, wherein said virtual phone client initiates a data call.

16. The wireless telephone of claim 11, wherein said wireless telephone parameters further comprise a location information associated with said wireless telephone.

17. The wireless telephone of claim 11, wherein said wireless telephone parameters further comprise a call billing policy associated with at least one of said virtual phone server and said Internet gateway.

18. The wireless telephone of claim 11, wherein said virtual phone client is further adapted to update information stored in said wireless telephone by communicating with said virtual phone server.

19. The wireless telephone of claim 11, wherein said virtual phone server is further adapted to communicate with said Internet gateway based on information stored in a memory of said virtual phone server.

20. A method for routing telephone calls using a wireless telephone comprising the steps of:
parsing dialing instructions based on at least one of a plurality of wireless telephone parameters, wherein said wireless telephone parameters include at least the wireless telephone location information; and
initiating a telephone call based on at least a portion of said parsed dialing instructions by transmitting instructions to a virtual phone server for routing said call via an Internet gateway.

21. The method of claim 20, further comprising pressing a “SEND” button on the wireless telephone to trigger parsing the dialing instructions.

22. The method of claim 20, further comprising a step of:
storing a telephone call's billing information.

23. A system for routing a call placed from a wireless telephone comprising
a virtual phone server configured to receive parsed dialing instructions from a wireless telephone, said virtual phone server further configured to update information stored by said wireless telephone based on at least one of parameters of said wireless telephone; and
wherein said virtual phone server is further configured to select an Internet gateway for routing a telephone call from said wireless telephone to a destination based on said parsed dialing instructions.

24. The system of claim 23, wherein said virtual phone server updates a location information associated with said wireless telephone.

25. The system of claim 23, wherein said virtual phone server updates a billing policy information associated with said Internet gateway.

26. A system for placing a telephone call from a wireless telephone comprising:
a virtual phone client in a wireless telephone; and
a virtual phone server configured to communicate with said virtual phone client and a Internet gateway; and
wherein said virtual phone client is configured to parse dialing instructions and establish a communications link between said virtual phone client and an Internet gateway based on instructions received from said virtual phone server.

27. The system of claim 26, wherein said virtual phone client is a residential software preloaded in the wireless telephone supporting download of JTAPI and TAPI application.

28. The system of claim 26, wherein said virtual phone client further comprises an application programming interface that is configured to facilitate retrieval of the wireless telephone's location information.

29. The system of claim 26, wherein said virtual phone client is configured to initiate a telephone call.

30. The system of claim 26, wherein said virtual phone client is configured to initiate a data call.

31. The system of claim 26, wherein said virtual phone server is further configured to update wireless telephone parameters stored by said virtual phone client.

32. The system of claim 31, wherein said wireless telephone parameters further comprise a location information associated with said wireless telephone.

33. The system of claim 31, wherein said wireless telephone parameters further comprise a call billing policy associated with at least one of said virtual phone server and said Internet gateway.

34. The system of claim 26, wherein said virtual phone client is further adapted to update information stored in said wireless telephone by communicating with said virtual phone server.

35. The system of claim 26, wherein said virtual phone server is further adapted to communicate with said Internet gateway based on information stored in a memory of said virtual phone server.

36. A system for placing a telephone call from a wireless telephone comprising:
a virtual phone client in a wireless telephone;
wherein said virtual phone client is configured to establish a communications link with the Internet gateway based on an address of said Internet gateway stored by said virtual phone client.
